(19) United States
(12) Patent Application Publication
(10) Pub. No.: US 2024/0413385 A1
(43) Pub. Date: Dec. 12, 2024

(54) BATTERY AND METHOD FOR PRODUCING SAME

(71) Applicant: TDK CORPORATION, Tokyo (JP)

(72) Inventors: Tetsuya UENO, Tokyo (JP); Takamasa MUKAI, Tokyo (JP)

(73) Assignee: TDK CORPORATION, Tokyo (JP)

(21) Appl. No.: 18/272,458

(22) PCT Filed: Jan. 17, 2022
(86) PCT No.: PCT/JP2022/001265

§ 371 Date: Jul. 14, 2023

(30) Foreign Application Priority Data
Jan. 18, 2021 (JP) 2021-005776

(51) Int. Cl. H01M 10/0562; H01M 50/618

(52) U.S. Cl. CPC H01M 10/0562; H01M 50/618; H01M 2300/008

(57) ABSTRACT

A battery (100) according to an embodiment includes a power storage element (10) which includes a positive electrode (11), a negative electrode (13), and a solid electrolyte layer (15) which is disposed between the positive electrode (11) and the negative electrode (13) and an exterior body (20) which covers the power storage element (10). At least one of the positive electrode (11), the negative electrode (13), and the solid electrolyte layer (15) contains a solid electrolyte represented by Li_{3+a-c}E_{1-b}G_{b}D_{c}X_{d-c} ⋅ ⋅ ⋅ (1) and an internal pressure in an accommodation space (K) enclosed by the exterior body (20) is less than 101.3 kPa.

### TECHNICAL FIELD

The present invention relates to a battery and a method for producing the same.

The present application claims priority on Japanese Patent Application No. 2021-005776 filed on Jan. 18, 2021, the content of which is incorporated herein by reference.

### BACKGROUND ART

In recent years, the development of electronics technique has been significant and efforts have been made to reduce the size, the weight, and the thickness of portable electronic devices and increase the multi-functionality of portable electronic devices. Along with this, there is a strong demand for smaller, lighter, thinner, and more reliable batteries which serve as power sources for electronic devices and all-solid-state batteries in which a solid electrolyte is used as an electrolyte have attracted attention.

Examples of the method for preparing an all-solid-state battery include a sintering method and a powder forming method. The sintering method includes: laminating a negative electrode, a solid electrolyte layer, and a positive electrode; and subsequently sintering the laminate to form an all-solid-state battery. The powder forming method includes: laminating a negative electrode, a solid electrolyte layer, and a positive electrode; and subsequently applying pressure to the laminate to form an all-solid-state battery. Materials which can be used for the solid electrolyte layer vary depending on the production methods. As solid electrolytes, oxide-based solid electrolytes, sulfide-based solid electrolytes, complex hydride-based solid electrolytes (LiBH₄ and the like), and the like are known.

Patent Document 1 discloses a solid electrolyte secondary battery including a positive electrode, a negative electrode, and a solid electrolyte composed of a compound represented by the general formula Li_{3-2X}M_{X}In_{1-Y}M′_{Y}L_{6-Z}L′_{Z}. In the general Formula shown above, M and M′ are metal elements and L and L′ are halogen elements. Furthermore, X, Y, and Z independently satisfy 0≤X<1.5, 0≤Y<1, and 0≤Z≤6. In addition, the positive electrode includes: a positive electrode layer which contains a positive electrode active material containing elemental Li; and a positive electrode current collector. Moreover, the negative electrode includes: a negative electrode layer which contains a negative electrode active material; and a negative electrode current collector.

Patent Document 2 discloses a solid electrolyte material represented by the following Composition Formula (1):

$${Li}_{6 - 3 Z} {Y}_{Z} {X}_{6} \qquad Formula ( 1 )$$

where 0<Z<2 is satisfied and X is Cl or Br.

Also, Patent Document 2 describes a battery in which at least one of a negative electrode and a positive electrode contains the solid electrolyte material described above.

Patent Document 3 describes an all-solid-state battery which includes an electrode active material layer having a first solid electrolyte material and a second solid electrolyte material. The first solid electrolyte material is a single-phase of a mixed electron-ion conductor which includes an active material and an anion component in contact with the active material and different from an anion component of the active material. The second solid electrolyte material is an ion conductor which is in contact with the first solid electrolyte material, includes an anion component that is the same as that of the first solid electrolyte material, and does not have electron conductivity. The first solid electrolyte material is Li₂ZrS₃.

However, all of the solid electrolytes described in Patent Documents 1 to 3 may not exhibit sufficient cycle characteristics in some cases.

### PRIOR ART DOCUMENTS

### Patent Documents

Patent Document 1: Japanese Unexamined Patent Application, First Publication No. 2006-244734
Patent Document 2: PCT International Publication No. WO 2018/025582
Patent Document 3: Japanese Unexamined Patent Application, First Publication No. 2013-257992

### DISCLOSURE OF INVENTION

### Problems to be Solved by the Invention

The present invention was made in view of the above-described problems, and an object of the present invention is to provide a battery having excellent cycle characteristics.

### Solutions for Solving the Problems

In order to solve the above problems, the inventors of the present invention have made extensive studies. As a result, the inventors of the present invention have found that, in a case where a power storage element is left in the atmosphere, a metal such as a current collector included in the power storage element corrodes and the performance of the power storage element deteriorates. That is to say, in order to solve the above-described problems, the following solutions are provided.

(1) A battery according to a first aspect includes: a power storage element including a positive electrode, a negative electrode, and a solid electrolyte layer located between the positive electrode and the negative electrode; and an exterior body covering the power storage element,
wherein at least one of the positive electrode, the negative electrode, and the solid electrolyte layer contains a solid electrolyte represented by the following Formula (1):

$${Li}_{3 + a - c} {E}_{1 - b} {G}_{b} {D}_{c} {X}_{d - c} , \qquad ( 1 )$$

in Formula (1),
E is at least one element selected from the group consisting of Al, Sc, Y, Zr, Hf, and lanthanides,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂,
X is at least one element selected from the group consisting of F, Cl, Br, and I, and
when n=(valence of E)−(valence of G), a=nb, 0≤b<0.5, 0≤c≤5, 0<d≤7.1, 0≤e≤2, and 0<d−e are satisfied, and
an internal pressure in an accommodation space enclosed by the exterior body is less than 101.3 kPa.

(2) In the battery according to the above-described aspect, the internal pressure may be less than an external pressure applied to the exterior body and a pressure difference between the external pressure and the internal pressure may be 30 kPa or more and 100 kPa or less.

(3) A method for producing a battery according to a second aspect includes:
an element preparation step of disposing a solid electrolyte layer between a positive electrode and a negative electrode and subjecting the positive electrode, the solid electrolyte layer, and the negative electrode to pressure-molding to prepare a power storage element;
a step of preparing an exterior body having an opening portion;
a step of accommodating the power storage element inside the exterior body; and
a step of making an inside of the exterior body have a vacuum state, setting an internal pressure in an accommodation space to be less than 101.3 kPa, and sealing the opening portion of the exterior body,
wherein at least one of the positive electrode, the negative electrode, and the solid electrolyte layer contains a solid electrolyte represented by the following Formula (1):

$${Li}_{3 + a - e} {E}_{1 - b} {G}_{b} {D}_{c} {X}_{d - e} , \qquad ( 1 )$$

in Formula (1),
E is at least one element selected from the group consisting of Al, Sc, Y, Zr, Hf, and lanthanides,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂, and
X is at least one element selected from the group consisting of F, Cl, Br, and I, and when n=(valence of E)−(valence of G), a=nb, 0≤b<0.5, 0≤c≤5, 0<d≤7.1, 0≤e≤2, and 0<d−e are satisfied.

### Effects of Invention

A battery according to the above aspects has excellent cycle characteristics.

### BRIEF DESCRIPTION OF DRAWINGS

FIG. 1 is a perspective view of an all-solid-state battery according to an embodiment.

FIG. 2 is a cross-sectional view of the all-solid-state battery of the embodiment.

### EMBODIMENTS FOR CARRYING OUT THE INVENTION

Embodiments will be described in detail below with reference to the drawings as appropriate. In the drawings used in the following explanation, the enlarged characteristic parts may be provided for convenience to make it easier to understand the characteristics of the present invention in some cases and dimensional ratios of each constituent element may differ from the actual ones in some cases. The materials, the dimensions, and the like exemplified in the following explanation are examples and the present invention is not limited to them. In addition, the embodiments can be implemented by appropriately modifying the materials, the dimensions, and the like exemplified in the following explanation within the range in which the effects of the present invention are exhibited.

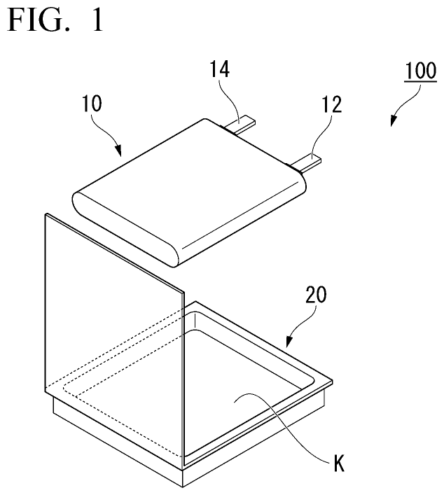

FIG. 1 is a perspective view of an all-solid-state battery 100 according to an embodiment. The all-solid-state battery 100 illustrated in FIG. 1 includes a power storage element 10 and an exterior body 20. The power storage element 10 is accommodated in an accommodation space K inside the exterior body 20. FIG. 1 illustrates a state just before the power storage element 10 is accommodated inside the exterior body 20 for ease of understanding. The power storage element 10 includes external terminals 12 and 14 which are electrically connected to an external device.

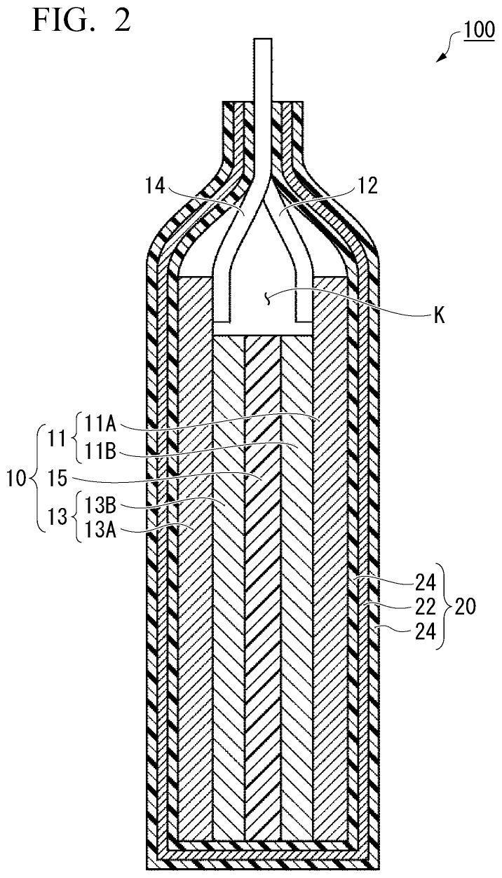

The exterior body 20 includes, for example, a metal foil 22 and resin layers 24 laminated on both sides of the metal foil 22 (refer to FIG. 2). The exterior body 20 is a metal laminate film obtained by coating both sides of the metal foil 22 with polymer films (resin layers 24). The metal foil 22 is, for example, an aluminum foil. Each of the resin layers 24 is, for example, a polymer film such as polypropylene and the like. The inner and outer resin layers 24 may be the same or different. For example, as the outer resin layer, polymers having high melting points such as, for example, polyethylene terephthalate (PET), polyamide (PA), and the like can be used, and as the inner resin layer, materials having high heat resistance, oxidation resistance, reduction resistance, corrosion resistance, and weather resistance such as polyethylene (PE), polypropylene (PP), polyvinyl chloride (PVC), tetrafluoroethylene resins (PTFE or TFE), fluoroethylene propylene resins (FEP), chlorotrifluoroethylene resins (CTFE), vinylidene fluoride resins, polyimide, and perfluorinated alkoxy resins (PFA), and the like can be used. From the viewpoint of further enhancing heat resistance, oxidation resistance, reduction resistance, corrosion resistance, and weather resistance, resin layers obtained by forming two or more kinds of resins in a matrix form or resin layers having a multi-layer structure of two or more layers may be used.

An internal pressure in the accommodation space K enclosed (surrounded) by the exterior body 20 is less than 101.3 kPa. The internal pressure in the accommodation space K is less than atmospheric pressure. The internal pressure means a pressure inside the accommodation space K. The internal pressure in the exterior body 20 is lower than an external pressure applied to the exterior body 20. The external pressure applied to the exterior body 20 is, for example, atmospheric pressure. A difference between the external pressure and the internal pressure applied to the exterior body 20 is, for example, kPa or higher and 100 kPa or lower, and preferably 50 kPa or higher and 100 kPa or lower. The internal pressure of the exterior body 20 is, for example, a value which is 30 kPa lower than the external pressure or less, preferably a value which is 50 kPa lower than the external pressure or less, and a value which is 100 kPa lower than the external pressure or higher.

In this way, it is possible to prevent the formation of a space between a positive electrode current collector 11A and a positive electrode active material layer 11B or a space between a negative electrode current collector 13A and a negative electrode active material layer 13B. A halogenated gas generated due to decomposition of the solid electrolyte is more likely to be accumulated in the space. It is possible to prevent contact between the halogenated gas and the current collector in the space by preventing the formation of the space between these layers. Thus, local deterioration of a current collection function is prevented and it is possible to conduct a uniform electrochemical reaction. As a result, the cycle characteristics (maintenance factor) of the all-solid-state battery 100 are improved.

Also, at the same time, in a case where the formation of the space is prevented, the adhesion between the positive electrode current collector 11A and the positive electrode active material layer 11B or the adhesion between the negative electrode current collector 13A and the negative electrode active material layer 13B is improved. Furthermore, occurrence of a non-uniform flow of a current bypassing the space is prevented. This makes the electrochemical reaction uniform and improves the cycle characteristics (maintenance factor) of the all-solid-state battery 100.

The internal pressure inside the exterior body 20 can be measured by accommodating the all-solid-state battery 100 inside the vacuum vessel and reducing a pressure inside the vacuum vessel. When the pressure inside the vacuum vessel is lowered below a certain value, the internal pressure of the exterior body 20 becomes greater than the external pressure and the exterior body 20 begins to swell. The pressure when the exterior body 20 begins to swell is assumed to be the internal pressure inside the exterior body 20.

The probability of reacting the solid electrolyte with a gas and moisture can be reduced and the generation of a halogenated gas can be prevented by making the inside of the exterior body 20 have a vacuum state to reduce amounts of gas and moisture present inside the exterior body 20. Halogenated gases are a cause of corrosion in metal parts (positive electrode current collector 11A, negative electrode current collector 13A, and the like which will be described later) in the power storage element 10 to deteriorate the current collection function. That is to say, corrosion of the positive electrode current collector 11A or the negative electrode current collector 13A in the all-solid-state battery 100 is prevented and the cycle characteristics (maintenance factor) of the all-solid-state battery 100 are improved by making the inside of the exterior body 20 have a vacuum state to reduce amounts of gas and moisture present inside the exterior body 20.

Also, when the inside of the exterior body 20 is made have a vacuum state, the amounts of gas and moisture present inside the exterior body 20 can be reduced and a side reaction of the solid electrolyte with the gas and moisture can be reduced. The side reaction of the solid electrolyte is a reaction accompanying the decomposition of the solid electrolyte and uses a portion of the energy used in performing charging or discharging. In a case where the side reaction of the solid electrolyte is prevented, the electrochemical stability of the solid electrolyte is improved. Furthermore, a portion of the energy used in performing charging or discharging is prevented from being used in the decomposition of the solid electrolyte and the cycle characteristics (maintenance factor) of the all-solid-state battery 100 are improved.

The gas included inside the exterior body 20 is, for example, at least one selected from argon, nitrogen, oxygen, carbonic acid, neon, helium, and hydrogen. The generation of the halogenated gas can be further prevented by controlling the gas included inside the exterior body 20.

FIG. 2 is a cross-sectional view of the all-solid-state battery 100 according to the embodiment. The all-solid-state battery 100 includes a positive electrode 11, a negative electrode 13, a solid electrolyte layer 15, external terminals 12 and 14, and an accommodation space K. The positive electrode 11 includes the positive electrode current collector 11A and the positive electrode active material layer 11B. The negative electrode 13 includes the negative electrode current collector 13A and the negative electrode active material layer 13B. The solid electrolyte layer 15 is located, for example, between the positive electrode active material layer 11B and the negative electrode active material layer 13B.

The all-solid-state battery 100 is charged or discharged through exchanging of electrons via the positive electrode current collector 11A and the negative electrode current collector 13A and exchanging of lithium ions via the solid electrolyte layer 15. The all-solid-state battery 100 may be a laminate obtained by laminating the positive electrode 11, the negative electrode 13, and the solid electrolyte layer 15 and may be a roll thereof. The all-solid-state battery 100 is used, for example, in a laminate battery, a rectangle battery, a cylindrical battery, a coin-shaped battery, a button-shaped battery, or the like.

An amount of moisture included in the power storage element 10 is preferably 0.01 mg/g or more and 1 mg/g or less per unit mass, and more preferably 0.01 mg/g or more and 0.5 mg/g or less per unit mass. The amount of moisture per unit mass included in the power storage element 10 is obtained by dividing a weight of the moisture included in the power storage element 10 by a weight of the power storage element 10. The amount of moisture included in the power storage element 10 can be measured by, for example, the Karl Fischer method.

In a case where the amount of moisture included in the power storage element 10 is 0.01 mg/g or more and 1 mg/g or less per unit mass, at the time of pressure molding, the particles that constitute the power storage element 10 flow; and thereby, it is possible to prevent the generation of cracks in the power storage element 10. In a case where the cracks in the power storage element 10 are prevented, the cycle characteristics (maintenance factor) of the all-solid-state battery 100 are improved. This is because the flow of a current and lithium ions bypassing the cracks is less likely to occur and it is possible to prevent local unevenness in charge and discharge reactions.

In a case where an amount of moisture included in the power storage element 10 is large, at the time of pressure molding, a jig and the power storage element 10 may come into close contact with each other in some cases. For this reason, cracks are more likely to occur at the time of removing the power storage element 10 from the jig. As described above, the cracks in the power storage element 10 can cause locally non-uniform charging and discharging reactions.

On the other hand, in a case where an amount of moisture included in the power storage element 10 is too little, at the time of pressure molding, the particles that constitute the power storage element 10 is less likely to flow, the adhesion between the particles becomes non-uniform, and cracks is more likely to occur in the power storage element 10. As described above, the cracks in the power storage element 10 cause locally non-uniform charging and discharging reactions and cause deterioration of the cycle characteristics (maintenance factor) of the all-solid-state battery 100.

The amount of moisture in the accommodation space K is, for example, 1100 ppmv or less. It is preferable that the amount of moisture in the accommodation space K be, for example, 0.5 ppmv or more and 600 ppmv or less. In a case where the amount of moisture in the accommodation space K is within the above-described range, the generation of a halogenated gas due to a reaction between the solid electrolyte and moisture can be prevented. The halogenated gas corrodes metal parts (current collector, conductive auxiliary agent, accommodation vessel, and the like) of the power storage element 10 and is one of the causes to deteriorate the current collection function. When the generation of the halogenated gas is prevented, it is possible to prevent the occurrence of locally non-uniform electrochemical reaction and the cycle characteristics (maintenance factor) of the all-solid-state battery 100 are further improved.

### “Solid Electrolyte Layer”

The solid electrolyte layer 15 contains a solid electrolyte. The solid electrolyte layer 15 contains, for example, a solid electrolyte represented by the following Formula (1):

$${Li}_{3 + a - e} {E}_{1 - b} {G}_{b} {D}_{c} {X}_{d - e} \qquad ( 1 )$$

In the foregoing Formula (1), E is a trivalent or tetravalent element. E is, for example, at least one element selected from the group consisting of Al, Sc, Y, Zr, Hf, and lanthanides. The lanthanides include La, Ce, Pr, Nd, Pm, Sm, Eu, Gd, Tb, Dy, Ho, Er, Tm, Yb, and Lu. When the solid electrolyte contains E elements, a potential window of the solid electrolyte widens. E preferably includes Sc or Zr, and particularly preferably Zr. When E includes Sc or Zr, the ion conductivity of the solid electrolyte increases.

In the solid electrolyte represented by the foregoing Formula (1), G is an element which is contained as necessary. G is at least one selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi. When the solid electrolyte contains an element of G, an amount of lithium ions that are carrier ions increases and the ion conductivity increases.

G in Formula (1) may be a monovalent element selected from Na, K, Rb, Cs, and Ag among the above-described elements. When G is a monovalent element, a solid electrolyte which has a high ion conductivity and a wide potential window on a reduction side is obtained. G is particularly preferably Na and/or Cs.

G in Formula (1) may be a divalent element selected from Mg, Ca, Ba, Sr, Cu, and Sn among the above-described elements. When G is a divalent element, carrier ions increase and a solid electrolyte which has a high ion conductivity and a wide potential window on a reduction side is obtained. G is particularly preferably Mg and/or Ca.

G in Formula (1) may be trivalent element selected from Al, Y, In, Au and Bi among the above-described elements. When G is a trivalent element, carrier ions increase and a solid electrolyte which has a high ion conductivity is obtained. G is preferably any one selected from the group consisting of In, Au, and Bi.

G in Formula (1) may be Zr, Hf, or Sn that are tetravalent elements among the above-described elements. When G is a tetravalent element, a solid electrolyte which has a high ion conductivity is obtained. G particularly preferably includes Hf and/or Zr.

G in Formula (1) may be a pentavalent element selected from Nb, Sb, and Ta among the above-described elements. When G is a pentavalent element, holes are formed and carrier ions are likely to move. Thus, a solid electrolyte which has a high ion conductivity is obtained. G particularly preferably includes Sb and/or Ta.

G in Formula (1) may be W that is a hexavalent element among the above-described elements. When G is a hexavalent element, a solid electrolyte which has a high ion conductivity is obtained.

D in Formula (1) is included as necessary. D is at least one selected from the group consisting of CO₃, SO₄, BO₃, PO₄, NO₃, SiO₃, OH, and O₂. When the solid electrolyte contains D, a potential window of the solid electrolyte on a reduction side widens. D is preferably at least one selected from the group consisting of SO₄, CO₃, PO₄, and O₂, and particularly preferably SO₄. The stronger the covalent bond between D and E, the stronger the ionic bond between E and X. For this reason, it is presumed that E in a compound is less likely to be reduced and the compound which has a wide potential window on a reduction side is obtained.

X in Formula (1) is an essential element. X is at least one selected from the group consisting of F, Cl, Br, and I. X has a large ion radius per valence. When the solid electrolyte includes X, the conductivity of lithium ions in the solid electrolyte increases. X preferably includes Cl in order to increase the ion conductivity of the solid electrolyte. X preferably includes F in order to improve the balance between the oxidation resistance and the reduction resistance of the solid electrolyte. X preferably includes 1 in order to increase the reduction resistance of the solid electrolyte.

In Formula (1), when n=(valence of E)−(valence of G), a=nb is satisfied. When b=0 in Formula (1) (when G is not included), a=0 is satisfied. In Formula (1), a is the above-described numerical value determined in accordance with the valence of G.

In Formula (1), b is 0 or more and less than 0.5. The solid electrolyte represented by Formula (1) contains E as an essential element, but may not contain G. In a case where b is 0.1 or more, the effect obtained by including G in the solid electrolyte can be sufficiently obtained. Furthermore, it is preferable that b be less than 0.5 from the viewpoint of preventing a decrease in the ion conductivity of the solid electrolyte. It is more preferable that b be 0.45 or less.

In Formula (1), c is 0 or more and 5 or less. Therefore, D may not be contained in the solid electrolyte. When D is contained in the compound represented by Formula (1), c is preferably 0.1 or more. In a case where c is 0.1 or more, the effect of widening the potential window on a reduction side of the solid electrolyte due to the inclusion of D is sufficiently obtained. In a case where an amount of D is too high, there is a concern that a space in which carrier ions move narrows; and thereby, the ion conductivity of the solid electrolyte decreases. From the viewpoint of preventing the decrease thereof, c is 5 or less, and preferably 2.5 or less.

In Formula (1), d is more than 0 and 7.1 or less. d is preferably 7.1 or less because, in a case where d is 7.1 or less, the binding force on carrier ions due to the excessive amount of X can be suppressed; and thereby, it is possible to prevent a decrease in the ion conductivity of the solid electrolyte.

In Formula (1), e is 0 or more and 2 or less. Furthermore, 0<d−e is satisfied. When Formula (1) satisfies 0≤e≤2 and 0<d−e, the amount of Li and the amount of X contained in the compound represented by Formula (1) are appropriate and the ion conductivity of the solid electrolyte increases.

In order to obtain a solid electrolyte which has a wide potential window and a high ion conductivity, it is preferable that E be Zr and X be Cl in the solid electrolyte represented by Formula (1). To be specifically, the compound represented by Formula (1) is preferably Li₂ZrCl₆, Li₂ZrCl₄SO₄, or Li₂ZrOCl₄ as a solid electrolyte having an excellent balance between ion conductivity and potential window.

The solid electrolyte layer 15 may contain other materials together with the solid electrolyte represented by Formula (1). Examples of the other materials include at least one compound selected from the group consisting of Li₂O, Li₂CO₃, LiX (X is at least one selected from the group consisting of F, Cl, Br, and I), Sc₂O₃, ScX₃ (X is at least one element selected from the group consisting of F, Cl, Br, and I), and GO, (G is at least one element selected from the group consisting of Na, K, Rb, Cs, Mg, Ca, Sr, Ba, B, Si, Al, Ti, Cu, Y, Zr, Nb, Ag, In, Sn, Sb, Hf, Ta, W, Au, and Bi. When the valence of G is m, n=m/2 is satisfied).

The ion conductivity of the solid electrolyte layer 15 increases when the solid electrolyte layer 15 contains the other materials described above. Although the details of the reason are unknown, it is considered as follows. In the solid electrolyte layer 15, the other materials described above have a function of helping the ionic connections between the particles of the solid electrolyte represented by Formula (1). Thus, it is presumed that the grain boundary resistance between the particles of the solid electrolyte represented by Formula (1) is reduced and the ion conductivity of the solid electrolyte layer 15 as a whole increases.

The amount of the other materials in the solid electrolyte layer 15 is, for example, 0.1% by mass or more and 1.0% by mass or less from the viewpoint of obtaining the effect of reducing the grain boundary resistance between particles. Furthermore, in a case where the amount of the other materials exceeds 1.0% by mass, the solid electrolyte layer is likely to crack and ionic connections between particles are hindered.

The solid electrolyte layer 15 may contain a binder. The solid electrolyte layer may contain, for example, fluorine-based resins such as polyvinylidene fluoride (PVDF), polytetrafluoroethylene (PTFE), and the like, cellulose, styrene-butadiene rubbers, ethylene-propylene rubbers, imide-based resins such as polyimide resins, polyamide-imide resins, and the like, ion conductive polymers, and the like. The ion conductive polymers are, for example, compounds obtained by combining a monomer of a polymer compound (polyether-based polymer compounds such as polyethylene oxide, polypropylene oxide, and the like, polyphosphazene, and the like) and a lithium salt such as LiCl₄, LiBF₄, LiPF₆, LiTFSI, and the like or an alkali metal salt containing lithium as a main component. The amount ratio of the binder is preferably 0.1% by volume or more and 30% by volume or less with respect to the total of the solid electrolyte layer 15. The binder helps to maintain excellent bonding between the solid electrolytes of the solid electrolyte layer 15, prevents the occurrence of cracks between the solid electrolytes, and prevents a decrease in ion conductivity and an increase in grain boundary resistance.

### “Positive Electrode”

As illustrated in FIG. 2, the positive electrode 11 includes, for example, the positive electrode current collector 11A and the positive electrode active material layer 11B containing a positive electrode active material.

### (Positive Electrode Current Collector)

It is preferable that the positive electrode current collector 11A have a high conductivity. For example, metals such as silver, palladium, gold, platinum, aluminum, copper, nickel, titanium, stainless steel, and the like, alloys thereof, and conductive resins can be used. The positive electrode current collector 11A may have a form such as powder, foil, punched forms, or expanded forms. From the viewpoint in which the current collection function of the positive electrode current collector 11A is not lowered, it is preferable that the moisture of the positive electrode current collector 11A be removed through drying by heating in vacuum or the like inside a glove box in which argon gas is circulated, and then the positive electrode current collector 11A be stored using a glass bottle, an aluminum laminate bag, or the like. The dew point inside the glove box is set to be, for example, −30° C. or lower and −90° C. or higher.

### (Positive Electrode Active Material Layer)

The positive electrode active material layer 11B is formed on one side or both sides of the positive electrode current collector 11A. The positive electrode active material layer 11B contains a positive electrode active material. The positive electrode active material layer 11B may contain, for example, a solid electrolyte represented by the foregoing Formula (1). Furthermore, the positive electrode active material layer 11B may contain a conductive auxiliary agent and a binder.

The positive electrode mixture used for the positive electrode active material layer 11B is prepared by, for example, mixing the positive electrode mixture by using an agate mortar, a pot mill, a blender, a hybrid mixer, or the like inside a glove box in which argon gas is circulated. From the viewpoint of performing excellent pressure molding of the power storage element 10, the dew point inside the glove box is preferably −30° C. or lower and −90° C. or higher. An oxygen concentration inside the glove box is, for example, 1 ppm or less.

### (Positive Electrode Active Material)

Examples of the positive electrode active material contained in the positive electrode active material layer 11B include lithium-containing transition metal oxides, transition metal fluorides, polyanions, transition metal sulfides, transition metal oxyfluorides, transition metal oxysulfides, and transition metal oxynitrides.

A positive electrode active material is not particularly limited as the positive electrode active material as long as it can reversibly allow progress of release and occlusion of lithium ions and extraction and insertion of lithium ions, and known positive electrode active materials used for lithium ion secondary batteries can be used as the positive electrode active material. Examples of the positive electrode active material include lithium cobaltate (LiCoO₂), lithium nickelate (LiNiO₂), lithium manganese spinel (LiMn₂O₄), complex metal oxides represented by the general formula: LiNiₓCo_{y}Mn_{z}MaO₂ (x+y+z+a=1, 0≤x≤1, 0≤y≤1, 0≤z≤1, 0≤a≤1, and M is one or more elements selected from Al, Mg, Nb, Ti, Cu, Zn, and Cr), and complex metal oxides such as lithium vanadium compounds (LiV₂O₅, Li₃V₂ (PO₄)₃, LiVOPO₄), olivine-type LiMPO₄ (where M represents one or more elements selected from Co, Ni, Mn, Fe, Mg, V, Nb, Ti, Al, and Zr), lithium titanate (Li₄Ti₅O₁₂), LiNiₓCo_{y}Al₂O₂ (0.9<x+y+z<1.1), and the like. From the viewpoint of performing excellent pressure molding of the positive electrode active material layer 11B, it is preferable that the moisture of the positive electrode active material used for the positive electrode active material layer 11B be removed through drying by heating in vacuum or the like inside a glove box in which argon gas is circulated, and then the positive electrode active material be stored using a glass bottle, an aluminum laminate bag, or the like. The dew point inside the glove box is preferably set to be −30° C. or lower and −90° C. or higher.

Also, in a case where lithium metal or a negative electrode active material doped with lithium ions is disposed in a negative electrode in advance, a positive electrode active material which does not contain lithium can also be used by starting the battery from discharging. Examples of this positive electrode active material include lithium-free metal oxides (MnO₂, V₂O₅, and the like), lithium-free metal sulfides (MoS₂ and the like), lithium-free fluorides (FeF₃, VF₃, and the like), and the like.

### “Negative Electrode”

As illustrated in FIG. 2, the negative electrode 13 includes, for example, the negative electrode current collector 13A and the negative electrode active material layer 13B containing a negative electrode active material.

### (Negative Electrode Current Collector)

It is preferable that the negative electrode current collector 13A have a high conductivity. For example, it is preferable to use metals such as silver, palladium, gold, platinum, aluminum, copper, nickel, stainless steel, iron, and the like, alloys thereof, and conductive resins. The negative electrode current collector 13A may have a form such as powder, foil, punched forms, or expanded forms. Furthermore, from the viewpoint in which the current collection function of the negative electrode current collector 13A is not lowered, it is preferable that the moisture of the negative electrode current collector 13A be removed through drying by heating in vacuum or the like inside a glove box in which argon gas is circulated, and then the negative electrode current collector 13A be stored using a glass bottle, an aluminum laminate bag, or the like. The dew point inside the glove box is set to be, for example, −30° C. or lower and −90° C. or higher.

### (Negative Electrode Active Material Layer)

The negative electrode active material layer 13B is formed on one side or both sides of the negative electrode current collector 13A. The negative electrode active material layer 13B contains a negative electrode active material. The negative electrode active material layer 13B may contain, for example, a solid electrolyte represented by the foregoing Formula (1). Furthermore, the negative electrode active material layer 13B may contain a conductive auxiliary agent and a binder.

The negative electrode mixture used for the negative electrode active material layer 13B is prepared by, for example, mixing the negative electrode mixture by using an agate mortar, a pot mill, a blender, a hybrid mixer, or the like inside a glove box in which argon gas is circulated. From the viewpoint of performing excellent pressure molding of the power storage element 10, the dew point inside the glove box is preferably −30° C. or lower and −90° C. or higher. An oxygen concentration inside the glove box is, for example, 1 ppm or less.

### (Negative Electrode Active Material)

The negative electrode active material contained in the negative electrode active material layer 13B may be any compound which can occlude and release mobile ions and known negative electrode active materials used for lithium ion secondary batteries can be used as the negative electrode active material. Examples of the negative electrode active material include single alkali metals, alkali metal alloys, carbon materials such as graphite (natural graphite and artificial graphite), carbon nanotube, non-graphitizable carbon, graphitizable carbon, low temperature calcined carbon, and the like, metals (aluminum, silicon, tin, germanium, alloys thereof, and the like) which can combine with metals of alkali metals and the like, oxides such as SiOₓ (0<x<2), iron oxides, titanium oxides, tin dioxides, and the like, and lithium metal oxides such as lithium titanate (Li₄Ti₅O₁₂) and the like. From the viewpoint of performing excellent pressure molding, the moisture of the negative electrode active material used for the negative electrode active material layer 13B may be removed through drying by heating in vacuum or the like inside a glove box in which argon gas is circulated, and then the negative electrode active material may be stored using a glass bottle, an aluminum laminate bag, or the like. The dew point inside the glove box is preferably set to be −30° C. or lower and −90° C. or higher.

### (Conductive Auxiliary Agent)

A conductive auxiliary agent is not particularly limited as long as it improves the electron conductivity of the positive electrode active material layer 11B and the negative electrode active material layer 13B, and known conductive auxiliary agents can be used as the conductive auxiliary agent. Examples of the conductive auxiliary agent include carbon-based materials such as graphite, carbon black, graphene, carbon nanotube, and the like, metals such as gold, platinum, silver, palladium, aluminum, copper, nickel, stainless steel, iron, and the like, conductive oxides such as ITO, and the like, and mixtures thereof. The conductive auxiliary agent may have a form such as powder and fiber forms. Furthermore, from the view point in which the current collection function of the conductive auxiliary agent is not lowered, the moisture of the conductive auxiliary agent may be removed through drying by heating in vacuum or the like inside a glove box in which argon gas is circulated, and then the conductive auxiliary agent may be stored using a glass bottle, an aluminum laminate bag, or the like. The dew point inside the glove box is preferably set to be −30° C. or lower and −90° C. or higher.

### (Binder)

A binder bonds the positive electrode current collector 11A and the positive electrode active material layer 11B, the binder bonds the negative electrode current collector 13A and the negative electrode active material layer 13B, the binder bonds any one of the positive electrode active material layer 11B and the negative electrode active material layer 13B, and the solid electrolyte layer 15, the binder bonds various materials constituting the positive electrode active material layer 11B, and the binder bonds various materials constituting the negative electrode active material layer 13B.

It is preferable that the binder be used within a range in which the functions of the positive electrode active material layer 11B and the negative electrode active material layer 13B are not impaired. A binder may be used as the binder as long as the above-described bonding is possible using the binder, and examples of the binder include fluorine resins such as polyvinylidene fluoride (PVDF), polytetrafluoroethylene (PTFE), and the like. Furthermore, other than the above-described binders, as the binder, for example, cellulose, styrene-butadiene rubbers, ethylene-propylene rubbers, polyimide resins, polyamide-imide resins, and the like may be used. Moreover, as the binder, conductive polymers having electron conductivity and ion conductive polymers having ion conductivity may be used. Examples of the conductive polymers having electron conductivity include polyacetylene and the like. In this case, it may not necessary to add the conductive auxiliary agent because the binder also exhibits the function of conductive auxiliary agent particles. As the ion conductive polymer having ion conductivity, for example, an ion conductive polymer which conducts lithium ions can be used, and examples of the ion conductive polymer include ion conductive polymer obtained by combining a monomer of a polymer compound (polyether-based polymer compounds such as polyethylene oxide, polypropylene oxide and the like, polyphosphazene, and the like), and a lithium salt such as LiClO₄, LiBF₄, LiPF₆, LiTFSI, LiFSI, and the like or an alkali metal salt containing lithium as a main component. Examples of polymerization initiators used for performing combing include photo-polymerization initiators, thermal polymerization initiators, and the like compatible with the monomers described above. Properties required for the binder include presence of oxidation/reduction resistance and excellent adhesiveness.

Although the amount of the binder in the positive electrode active material layer 11B is not particularly limited, from the viewpoint of lowering the resistance of the positive electrode active material layer 11B, the amount is preferably 0.5 to 30% by volume of the positive electrode active material layer. Furthermore, from the viewpoint of improving the energy density, the amount of the binder in the positive electrode active material layer 11B is preferably 0% by volume.

Although the amount of the binder in the negative electrode active material layer 13B is not particularly limited, from the viewpoint of lowering the resistance of the negative electrode active material layer 13B, the amount is preferably 0.5 to 30% by volume of the negative electrode active material layer. Furthermore, from the viewpoint of improving the energy density, the amount of the binder in the negative electrode active material layer 13B is preferably 0% by volume.

A non-aqueous electrolyte solution, an ion liquid, and a gel electrolyte may be mixed in at least one of the positive electrode active material layer 11B, the negative electrode active material layer 13B, and the solid electrolyte layer 15 for the purpose of improving rate characteristics which are one of battery characteristics.

### “Method for Producing Solid Electrolyte”

A method for producing a solid electrolyte represented by Formula (1) will be described. The solid electrolyte is obtained by mixing and reacting raw material powders at a predetermined molar ratio to obtain a desired composition. Although any reaction method may be used, a mechanochemical milling method, a sintering method, a melting method, a liquid phase method, a solid phase method, or the like can be used.

The solid electrolyte can be produced by, for example, a mechanochemical milling method. First, a planetary ball mill device is prepared. The planetary ball mill device is a device in which media (hard balls for performing pulverization or prompting mechanochemical reactions) and materials are put into a dedicated container and the pulverzation of the materials or the mechanochemical reactions between the materials are caused through rotation and revolution of the dedicated container.

The solid electrolyte is prepared, for example, inside a glove box in which argon gas is circulated. From the viewpoint of stably synthesizing a desired compound, it is preferable that the dew point inside the glove box be, for example, −20° C. or lower and −90° C. or higher, and preferably −30° C. or lower and −80° C. or higher. An oxygen concentration inside the glove box is set to be, for example, 1 ppm or less.

Subsequently, predetermined raw materials are prepared in a zirconia container at a predetermined molar ratio to obtain a desired composition, and the zirconia container is sealed with a zirconia lid. A predetermined amount of zirconia balls is prepared in the zirconia container. The raw material may have a powder or liquid form. For example, titanium chloride (TiCl₄), tin chloride (SnCl₄), and the like are liquid at room temperature. Subsequently, a mechanochemical reaction occurs by performing mechanochemical milling for a predetermined time at predetermined rotation and revolution speeds. Through this method, a powdery solid electrolyte composed of a compound having a desired composition can be obtained.

“Method for Producing all-Solid-State Battery”

A method for producing the all-solid-state battery according to the embodiment will be described below. The all-solid-state battery according to the embodiment is prepared by, for example, a powder molding method. The preparation through the powder forming method is also performed inside a glove box. It is preferable that the dew point inside the glove box be, for example, −20° C. or lower and −90° C. or higher. An oxygen concentration inside the glove box is set to be, for example, 1 ppm or less.

### (Powder Molding Method)

First, a resin holder having a through hole in a center thereof, a lower punch, and an upper punch are prepared. A metal holder made of die steel may be used instead of the resin holder to improve moldability. A diameter of the through hole of the resin holder is, for example, 10 mm and diameters of the lower punch and the upper punch are, for example, 9.99 mm. The lower punch is inserted from below the through hole of the resin holder and a powdery solid electrolyte is introduced from an opening side of the resin holder. Subsequently, the upper punch is inserted on the introduced powdery solid electrolyte and placed on a pressing machine and pressing is performed. A press pressure is, for example, 373 MPa. The solid electrolyte layer 15 is obtained by pressing the powdery solid electrolyte using the upper punch and the lower punch inside the resin holder.

Subsequently, the upper punch is temporarily removed and the material for the positive electrode active material layer is introduced on the upper punch side of the solid electrolyte layer 15. After that, the upper punch is inserted again and pressing is performed. The press pressure is, for example, 373 MPa. The material for the positive electrode active material layer is converted to the positive electrode active material layer 11B through pressing.

Subsequently, the lower punch is temporarily removed and the material for the negative electrode active material layer is introduced on the lower punch side of the solid electrolyte layer 15. For example, a sample is turned upside down and the material for the negative electrode active material layer is introduced on the solid electrolyte layer 15 to face the positive electrode active material layer 11B. After that, the lower punch is inserted again and pressing is performed. The press pressure is, for example, 373 MPa. The material for the negative electrode active material layer is converted to the negative electrode active material layer 13B through pressing.

Subsequently, the upper punch is temporarily removed and the positive electrode current collector 11A and the upper punch are inserted in this order on the positive electrode active material layer 11B. Furthermore, the lower punch is once removed and the negative electrode current collector 13A and the lower punch are inserted in this order on the negative electrode active material layer 13B. The positive electrode current collector 11A and the negative electrode current collector 13A are, for example, formed of an aluminum foil or a copper foil having a diameter of 10 mm. Through the above-described procedure, the power storage element 10 of the embodiment including the positive electrode current collector 11A/positive electrode active material layer 11B/solid electrolyte layer 15/negative electrode active material layer 13B/negative electrode current collector 13A is obtained.

As necessary, the power storage element 10 may be loaded in an order of stainless steel disk/Bakelite disk/upper punch/the power storage element 10/lower punch/Bakelite disk/stainless steel disk using the stainless steel disks and the Bakelite disks having four screw holes and the laminate may be tightened using four screws. With the above-described constitution, each of the bondability between the upper punch and the positive electrode current collector 11A, the bondability between the positive electrode current collector 11A and the positive electrode active material 11B, the bondability between the lower punch and the negative electrode current collector 13A, and the bondability between the negative electrode current collector 13A and the negative electrode active material layer 13B is improved. The power storage element 10 may be a similar mechanism having a shape-retaining function.

Subsequently, screws are put into screw holes provided in the side surfaces of the upper punch and the lower punch, the laminate is inserted into an exterior body having external terminals 12 and 14 attached thereto, and the screws attached to the side surfaces of the upper punch and the lower punch are connected to the external terminals 12 and 14 using lead wires or the like. After that, it is accommodated inside an exterior body 20. The exterior body 20 improves the weather resistance of the all-solid-state battery 100.

Subsequently, the exterior body 20 is heat-sealed except for one opening portion. After that, the remaining opening portion is heat-sealed while the inside of the exterior body 20 is made have a vacuum state. To be specific, the internal pressure inside the accommodation space K of the exterior body 20 is set to less than 101.3 kPa, and while this state is maintained, the opening portion of the exterior body 20 is sealed. Sealing can be performed while preventing the formation of a space between the positive electrode current collector 11A and the positive electrode active material layer 11B or a space between the negative electrode current collector 13A and the negative electrode active material layer 13B by performing heat-sealing while making the inside of the exterior body 20 have a vacuum state. Furthermore, the exterior body 20 can be sealed with a small amount of gas and moisture present in the accommodation space K.

Although the method for producing the power storage element 10 described above has been described using the powder molding method as an example, the power storage element 10 may be produced using a sheet molding method containing a resin. The preparation through the sheet molding method is also performed inside a glove box. It is preferable that the preparation inside the glove box be conducted, for example, in an environment in which the dew point is −20° C. or lower and −90° C. or higher.

For example, first, a solid electrolyte paste containing a powdery solid electrolyte is prepared. The solid electrolyte layer 15 is prepared by coating the prepared solid electrolyte paste on a PET film, a fluorine-based resin film, or the like, drying the solid electrolyte paste, performing pre-forming, and performing peeling. Furthermore, the positive electrode 11 is prepared by coating a positive electrode active material paste containing a positive electrode active material on the positive electrode current collector 11A, drying the positive electrode active material paste, and performing pre-forming to form the positive electrode active material layer 11B. In addition, the negative electrode 13 is prepared by coating a paste containing a negative electrode active material on the negative electrode current collector 13A, drying the paste, and performing pre-forming to form the negative electrode active material layer 13B. The positive electrode 11, the negative electrode 13, and the solid electrolyte layer 15 can be punched to have a required size and shape.

Subsequently, the solid electrolyte layer 15 is disposed between the positive electrode 11 and the negative electrode 13 so that the positive electrode active material layer 11B faces the negative electrode active material layer 13B and the whole is pressed and bonded. Through the steps described above, the power storage element 10 of the embodiment is obtained.

In the all-solid-state battery 100 according to the embodiment, a difference is provided between the external pressure and the internal pressure applied to the exterior body 20; and thereby, a decrease in current collection function due to corrosion of the positive electrode current collector 11A or the negative electrode current collector 13AA caused by halogenated gas is prevented and it is possible to conduct a uniform electrochemical reaction. Thus, the cycle characteristics (maintenance factor) of the all-solid-state battery 100 are improved.

Although the embodiments of the present invention have been described in detail above with reference to the drawings, constitutions, a combination thereof, and the like in the embodiments are examples and additions, omissions, substitutions, and other modifications of the constitutions are possible without departing from the features of the present invention.

### EXAMPLES

### Example 1

### —Synthesize of Solid Electrolyte—

Synthesize of a solid electrolyte, mixing of materials of a positive electrode active material layer, mixing of materials of a negative electrode active material layer, and preparation of an all-solid-state battery were performed inside a glove box in an atmospheric pressure environment in which argon gas was circulated and a dew point was −90° C. and an oxygen concentration was 1 ppm. First, as raw material powders, Li₂SO₄ and ZrCl₄ were weighed so that the molar ratio thereof was 1:1. Subsequently, the weighed raw material powders were put in a Zr container together with Zr balls having a diameter of 5 mm, and mechanochemical milling processing was performed using a planetary ball mill. The processing was carried out by performing mixing for 50 hours at a rotation speed of 500 rpm and then performing sieving through a 200 μm mesh. Thus, Li₂ZrSO₄Cl₄ powder was obtained as a solid electrolyte.

### —Synthesize of Positive Electrode Mixture—

Subsequently, a positive electrode mixture was weighed and mixed inside a glove box in which argon gas was circulated, a dew point was −85° C., and an oxygen concentration was 1 ppm. Materials were weighed so that lithium cobaltate (LiCoO₂): solid electrolyte (Li₂ZrSO₄Cl₄): carbon black=77:18:5 parts by weight was satisfied and the mixture was mixed in an agate mortar for 5 minutes to obtain the positive electrode mixture.

### —Preparation of Negative Electrode Mixture—

Subsequently, a negative electrode mixture was weighed and mixed inside a glove box in which argon gas was circulated, a dew point was −85° C., and an oxygen concentration was 1 ppm. Materials were weighed so that lithium titanate (Li₄Ti₅O₁₂): solid electrolyte (Li₂ZrSO₄Cl₄): carbon black=72:22:6 parts by weight was satisfied and the mixture was mixed in an agate mortar for 5 minutes to obtain the negative electrode mixture.

### —Molding Step—

A power storage element composed of the positive electrode current collector/positive electrode mixture layer/electrolyte layer/negative electrode mixture layer/negative electrode current collector was prepared by the powder molding method using the solid electrolyte, the positive electrode mixture, and the negative electrode mixture described above. The power storage element was prepared inside a glove box in which argon gas was circulated, a dew point was −90° C., and an oxygen concentration was 1 ppm.

First, a resin holder having a through hole with a diameter of 10 mm in a center thereof, a lower punch and an upper punch which had a diameter of 9.99 mm and were made of an SKD11 material were prepared. The lower punch was inserted from below the through hole of the resin holder and 110 mg of the solid electrolyte was introduced from an opening side of the resin holder. Subsequently, the upper punch was inserted above the solid electrolyte. A solid electrolyte layer was formed by placing this first unit on a pressing machine and pressing the first unit at a pressure of 373 MPa. The first unit was removed from the pressing machine and the upper punch was removed.

Subsequently, 12 mg of the positive electrode mixture was introduced on the solid electrolyte layer (upper punch side) from the opening side of the resin holder and the upper punch was inserted thereon. This second unit was placed on the pressing machine and molded at a pressure of 373 MPa. Subsequently, the second unit was removed and turned upside down, and the lower punch was removed.

Subsequently, 10 mg of the negative electrode mixture was introduced on the solid electrolyte layer (lower punch side), the lower punch was inserted thereon, this third unit was placed on the pressing machine and molded at a pressure of 373 MPa.

Subsequently, the upper punch was once removed and the positive electrode current collector (aluminum foil, diameter of 10 mm, thickness of 20 μm) and the upper punch were inserted in this order on the positive electrode active material layer. Furthermore, the lower punch was once removed and the negative electrode current collector (copper foil, diameter of 10 mm, thickness of 10 μm) and the lower punch were inserted in this order on the negative electrode active material layer. Thereby, a fourth unit was obtained. In this way, a power storage element composed of the positive electrode current collector/positive electrode active material layer/solid electrolyte layer/negative electrode active material layer/negative electrode current collector was prepared.

After that, stainless steel disks and Bakelite disks which had four screw holes, a diameter of 50 mm, and a thickness of 5 mm were prepared and battery elements were set as follows. The stainless steel disk/Bakelite disk/fourth unit/Bakelite disk/stainless steel disk were loaded in this order and four screws were tightened to prepare a fifth unit. Screws for connecting external terminals were put into screw holes in the side surfaces of the upper punch and the lower punch.

### —Accommodation Step—

Subsequently, the obtained power storage element was accommodated in an exterior body. The power storage element was accommodated in a dry room which has a dew point of −50° C.

An A4 size aluminum laminate bag was prepared as the exterior body for enclosing the fifth unit therein. An aluminum foil (width of 4 mm, length of 40 mm, thickness of 100 μm) wrapped with maleic anhydride-grafted polypropylene (PP) and a nickel foil (width of 4 mm, length of 40 mm, thickness of 100 μm) were thermally bonded with one side of an opening portion of the aluminum laminate bag as external terminals at intervals so that a short circuit was not caused. The fifth unit was inserted into the aluminum laminate bag having the external terminals attached thereto, and the screw in the side surface of the upper punch and the aluminum terminal extending into the inside the exterior body were connected using a lead wire, and the screw in the side surface of the lower punch and the nickel terminal extending into the inside of the exterior body were connected using a lead wire.

Finally, an all-solid-state battery is obtained by heat-sealing the opening portion while making the inside of the exterior body have a vacuum state having a degree of vacuum up to −50 kPa (converted when an atmospheric pressure was assumed to be 0 kPa). The internal pressure inside the exterior body was 51.3 kPa. A difference between the external pressure and the internal pressure was 50 kPa.

After performing the following charge/discharge test, the positive electrode current collector and the negative electrode current collector were taken out, surfaces which were in contact with the positive electrode active material layer or the negative electrode active material layer were observed using an optical microscope (50-power magnifying objective lens), and an area of a portion whose contrast was different from that of an unused positive electrode current collector or an unused negative electrode current collector was obtained. It was assumed that the contrast change was accompanied by cracks.

Also, the prepared all-solid-state battery was subjected to the charge/discharge test. The charge/discharge test was performed inside a thermostatic chamber at 25° C. Charging was performed at 0.05 C up to 2.8 V with constant current and constant voltage (referred to as “CCCV”). The charging was terminated when a current reached 1/40 C. In discharging, constant current discharging was performed at 0.05 C up to 1.3 V. 50 cycles of charging and discharging were performed under the above-described conditions and the maintenance factor after 50 cycles was calculated using the following Formula (2).

$$Maintenance factor [ \% ] = ( discharge capacity [ Ah ] at 50 th cycle / charge capacity [ Ah ] at first cycle ) ⨯ 100 \qquad ( 2 )$$

The results of Example 1 are summarized in Tables 1 to 5 which will be shown later.

### Examples 2 to 10

Examples 2 to 10 differed from Example 1 in that a degree of vacuum inside of the exterior body was changed. Other conditions were the same as in Example 1, and the color change of the positive electrode current collector and the negative electrode current collector was observed, and the maintenance factor of the all-solid-state battery was measured. The results of Examples 2 to 10 are summarized in Table 1 which will be shown later.

### Comparative Example 1

Comparative Example 1 differed from Example 1 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 1, and the color change of the positive electrode current collector and the negative electrode current collector was observed, and the maintenance factor of the all-solid-state battery was measured. The results of Comparative Example 1 are summarized in Table 1 which will be shown later.

### Example 11

In Example 11, a composition of a solid electrolyte was changed. Example 11 differed from Example 1 in that a solid electrolyte Li₂ZrCl₆ was obtained by weighing LiCl and ZrCl₄ as raw material powders in a molar ratio of 2:1 and subjecting the mixture to mechanochemical milling processing and the solid electrolyte Li₂ZrCl₆ was used. Other conditions were the same as in Example 1, and the color change of the positive electrode current collector and the negative electrode current collector was observed, and the maintenance factor of the all-solid-state battery was measured. The results of Example 11 are summarized in Table 1 which will be shown later.

### Examples 12 to 20

Examples 12 to 20 differed from Example 11 in that a degree of vacuum inside an exterior body was changed. Other conditions were the same as in Example 11, and the color change of the positive electrode current collector and negative electrode current collector was observed, and the maintenance factor of the all-solid-state battery was measured. The results of Examples 12 to 20 are summarized in Table 1 which will be shown later.

### Comparative Example 2

Comparative Example 2 differed from Example 11 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 11, and the color change of the positive electrode current collector and the negative electrode current collector was observed, and the maintenance factor of the all-solid-state battery was measured. The results of Comparative Example 2 are summarized in Table 1 which will be shown later.

### Example 21

In Example 21, a composition of a solid electrolyte was changed. Example 21 differed from Example 1 in that a solid electrolyte Li₂ZrOCl₄ was obtained by weighing Li₂O and ZrCl₄ as raw material powders in a molar ratio of 1:1 and subjecting the mixture to mechanochemical milling processing and the solid electrolyte Li₂ZrOCl₄ was used. Other conditions were the same as in Example 1, and the color change of the positive electrode current collector and the negative electrode current collector was observed, and the maintenance factor of the all-solid-state battery was measured. The results of Example 21 are summarized in Table 2 which will be shown later.

### Examples 22 to 30

Examples 22 to 30 differed from Example 21 in that a degree of vacuum inside an exterior body was changed. Other conditions were the same as in Example 21, and the color change of the positive electrode current collector and the negative electrode current collector was observed, and the maintenance factor of all-solid-state battery was measured. The results of Examples 22 to 30 are summarized in Table 2 which will be shown later.

### Comparative Example 3

Comparative Example 3 differed from Example 21 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 21, and the color change of the positive electrode current collector was observed, and the negative electrode current collector and the maintenance factor of the all-solid-state battery was measured. The results of Comparative Example 3 are summarized in Table 2 which will be shown later.

### Example 31

In Example 31, a composition of a solid electrolyte was changed. Example 31 differed from Example 1 in that a solid electrolyte LiZr(PO₄)_{0.33}Cl₄ was obtained by weighing Li₃PO₄ and ZrCl₄ as raw material powders in a molar ratio of 1:3 and subjecting the mixture to mechanochemical milling processing and the solid electrolyte LiZr(PO₄)_{0.33}Cl₄ was used. Other conditions were the same as in Example 1, and the color change of the positive electrode current collector and the negative electrode current collector was observed, and the maintenance factor of the all-solid-state battery was measured. The results of Example 31 are summarized in Table 2 which will be shown later.

### Example 32 to 40

Examples 32 to 40 differed from Example 31 in that a degree of vacuum inside an exterior body was changed. Other conditions were the same as in Example 31, and the color change of the positive electrode current collector and the negative electrode current collector was observed, and the maintenance factor of the all-solid-state battery was measured. The results of Examples 32 to 40 are summarized in Table 2 which will be shown later.

### Comparative Example 4

Comparative Example 4 differed from Example 31 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 31, and the color change of the positive electrode current collector and the negative electrode current collector was observed, and the maintenance factor of the all-solid-state battery was measured. The results of Comparative Example 4 are summarized in Table 2 which will be shown later.

### Example 41

In Example 41, a composition of a solid electrolyte was changed. Example 41 differed from Example 1 in that a solid electrolyte LiY(PO₄)_{0.33}Cl₃ was obtained by weighing Li₃PO₄ and YCl₃ as raw material powders in a molar ratio of 1:3 and subjecting the mixture to mechanochemical milling processing and the solid electrolyte LiY(PO₄)_{0.33}Cl₃ was used. Other conditions were the same as in Example 1, and the color change of the positive electrode current collector and the negative electrode current collector was observed, and the maintenance factor of the all-solid-state battery was measured. The results of Example 41 are summarized in Table 3 which will be shown later.

### Examples 42 to 50

Examples 42 to 50 differed from Example 41 in that a degree of vacuum inside an exterior body was changed. Other conditions were the same as in Example 41, and the color change of the positive electrode current collector and the negative electrode current collector was observed, and the maintenance factor of the all-solid-state battery was measured. The results of Examples 42 to 50 are summarized in Table 3 which will be shown later.

### Comparative Example 5

Comparative Example 5 differed from Example 41 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 41, and the color change of the positive electrode current collector and the negative electrode current collector was observed, and the maintenance factor of the all-solid-state battery was measured. The results of Comparative Example 5 are summarized in Table 3 which will be shown later.

### Example 51

In Example 51, a composition of a solid electrolyte was changed. Example 51 differed from Example 1 in that a solid electrolyte Li_{1.3}Al_{0.3}Zr_{0.7}(PO₄)_{0.43}Cl_{3.7} was obtained by weighing Li₃PO₄, ZrCl₄, and AlCl; as raw material powders in a molar ratio of 4.3:7:3 and subjecting the mixture to mechanochemical milling processing and the solid electrolyte Li_{1.3}Al_{0.3}Zr_{0.7}(PO₄)_{0.43}Cl_{3.7} was used. Other conditions were the same as in Example 1, and the color change of the positive electrode current collector and the negative electrode current collector was observed, and the maintenance factor of the all-solid-state battery was measured. The results of Example 51 are summarized in Table 3 which will be shown later.

### Examples 52 to 60

Examples 52 to 60 differed from Example 51 in that a degree of vacuum inside an exterior body was changed. Other conditions were the same as in Example 51, and the color change of the positive electrode current collector and the negative electrode current collector was observed, and the maintenance factor of the all-solid-state battery was measured. The results of Examples 52 to 60 are summarized in Table 3 which will be shown later.

### Comparative Example 6

Comparative Example 6 differed from Example 51 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 51, and the color change of the positive electrode current collector and the negative electrode current collector was observed, and the maintenance factor of the all-solid-state battery was measured. The results of Comparative Example 6 are summarized in Table 3 which will be shown later.

### Example 61

In Example 61, a composition of a solid electrolyte was changed. Example 61 differed from Example 1 in that a solid electrolyte Li_{1.8}Zr(SO₄)_{0.9}Cl₄ was obtained by weighing Li₂SO₄ and ZrCl₄ as raw material powders in a molar ratio of 0.9:1 and subjecting the mixture to mechanochemical milling processing and the solid electrolyte Li_{1.8}Zr(SO₄)_{0.9}Cl₄ was used. Other conditions were the same as in Example 1, and the color change of the positive electrode current collector and the negative electrode current collector was observed, and the maintenance factor of the all-solid-state battery was measured. The results of Example 61 are summarized in Table 4 which will be shown later.

### Examples 62 to 70

Examples 62 to 70 differed from Example 61 in that a degree of vacuum inside an exterior body was changed. Other conditions were the same as in Example 61, and the color change of the positive electrode current collector and the negative electrode current collector was observed, and the maintenance factor of the all-solid-state battery was measured. The results of Examples 62 to 70 are summarized in Table 4 which will be shown later.

### Comparative Example 7

Comparative Example 7 differed from Example 61 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 61, and the color change of the positive electrode current collector and the negative electrode current collector was observed, and the maintenance factor of the all-solid-state battery was measured. The results of Comparative Example 7 are summarized in Table 4 which will be shown later.

### Example 71

In Example 71, a composition of a solid electrolyte was changed. Example 71 differed from Example 1 in that a solid electrolyte Li_{2.2}Zr(SO₄)_{1.1}Cl₄ was obtained by weighing Li₂SO₄ and ZrCl₄ as raw material powders in a molar ratio of 1.1:1 and subjecting the mixture to mechanochemical milling processing and the solid electrolyte Li_{2.2}Zr(SO₄)_{1.1}Cl₄ was used. Other conditions were the same as in Example 1, and the color change of the positive electrode current collector and the negative electrode current collector was observed, and the maintenance factor of the all-solid-state battery was measured. The results of Example 71 are summarized in Table 4 which will be shown later.

### Examples 72 to 80

Examples 72 to 80 differed from Example 71 in that a degree of vacuum inside an exterior body was changed. Other conditions were the same as in Example 71, and the color change of the positive electrode current collector and the negative electrode current collector was observed, and the maintenance factor of the all-solid-state battery was measured. The results of Examples 72 to 80 are summarized in Table 4 which will be shown later.

### Comparative Example 8

Comparative Example 8 differed from Example 71 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 71, and the color change of the positive electrode current collector and the negative electrode current collector was observed, and the maintenance factor of the all-solid-state battery was measured. The results of Comparative Example 8 are summarized in Table 4 which will be shown later.

### Example 81

In Example 81, a composition of a solid electrolyte was changed. Example 81 differed from Example 1 in that a solid electrolyte Li₃Zr(SO₄)_{1.5}Cl₄ was obtained by weighing Li₂SO₄ and ZrCl₄ as raw material powders in a molar ratio of 1.5:1 and subjecting the mixture to mechanochemical milling processing and the solid electrolyte Li₃Zr(SO₄)_{1.5}Cl₄ was used. Other conditions were the same as in Example 1, and the color change of the positive electrode current collector and the negative electrode current collector was observed, and the maintenance factor of the all-solid-state battery was measured. The results of Example 81 are summarized in Table 5 which will be shown later.

### Examples 82 to 90

Examples 82 to 90 differed from Example 81 in that a degree of vacuum inside an exterior body was changed. Other conditions were the same as in Example 81, and the color change of the positive electrode current collector and the negative electrode current collector was observed, and the maintenance factor of the all-solid-state battery was measured. The results of Examples 82 to 90 are summarized in Table 5 which will be shown later.

### Comparative Example 9

Comparative Example 9 differed from Example 81 in that the inside of an exterior body was not made have a vacuum state when heat-sealing an opening portion of the exterior body. The internal pressure was 101.3 kPa. A difference between the external pressure and the internal pressure was 0 kPa. Other conditions were the same as in Example 81 and the color change of the positive electrode current collector and the negative electrode current collector was observed, and the maintenance factor of the all-solid-state battery was measured. The results of Comparative Example 9 are summarized in Table 5 which will be shown later.

TABLE 1

| | | Degree of vacuum | Internal | Difference between external | | |
|---|---|---|---|---|---|---|
| | | inside exterior body | pressure | pressure and internal | Discoloration | Maintenance |
| Example | Composition | [kPa] | [kPa] | pressure [kPa] | area (mm²) | factor [%] |
| Comparative | Li₂ZrSO₄Cl₄ | 0 | 101.3 | 0 | 20 | 54 |
| Example 1 | | | | | | |
| Example 1 | Li₂ZrSO₄Cl₄ | −50 | 51.3 | 50 | 1.1 | 92 |
| Example 2 | Li₂ZrSO₄Cl₄ | −60 | 41.3 | 60 | 0.89 | 95 |
| Example 3 | Li₂ZrSO₄Cl₄ | −70 | 31.3 | 70 | 0.66 | 96 |
| Example 4 | Li₂ZrSO₄Cl₄ | −80 | 21.3 | 80 | 0.56 | 97 |
| Example 5 | Li₂ZrSO₄Cl₄ | −90 | 11.3 | 90 | 0.29 | 98 |
| Example 6 | Li₂ZrSO₄Cl₄ | −100 | 1.3 | 100 | 0.25 | 98 |
| Example 7 | Li₂ZrSO₄Cl₄ | −10 | 91.3 | 10 | 8.8 | 78 |
| Example 8 | Li₂ZrSO₄Cl₄ | −20 | 81.3 | 20 | 7.5 | 79 |
| Example 9 | Li₂ZrSO₄Cl₄ | −30 | 71.3 | 30 | 5.5 | 86 |
| Example 10 | Li₂ZrSO₄Cl₄ | −40 | 61.3 | 40 | 3.5 | 89 |
| Comparative | Li₂ZrCl₆ | 0 | 101.3 | 0 | 18.9 | 56 |
| Example 2 | | | | | | |
| Example 11 | Li₂ZrCl₆ | −10 | 91.3 | 10 | 9.1 | 69 |
| Example 12 | Li₂ZrCl₆ | −20 | 81.3 | 20 | 7.9 | 77 |
| Example 13 | Li₂ZrCl₆ | −30 | 71.3 | 30 | 5.4 | 79 |
| Example 14 | Li₂ZrCl₆ | −40 | 61.3 | 40 | 3.8 | 86 |
| Example 15 | Li₂ZrCl₆ | −50 | 51.3 | 50 | 2.5 | 90 |
| Example 16 | Li₂ZrCl₆ | −60 | 41.3 | 60 | 0.9 | 94 |
| Example 17 | Li₂ZrCl₆ | −70 | 31.3 | 70 | 0.87 | 95 |
| Example 18 | Li₂ZrCl₆ | −80 | 21.3 | 80 | 0.5 | 96 |
| Example 19 | Li₂ZrCl₆ | −90 | 11.3 | 90 | 0.27 | 98 |
| Example 20 | Li₂ZrCl₆ | −100 | 1.3 | 100 | 0.26 | 97 |

TABLE 2

| | | Degree of vacuum | Internal | Difference between | | |
|---|---|---|---|---|---|---|
| | | inside exterior | pressure | external pressure and | Discoloration | Maintenance |
| Example | Composition | body [kPa] | [kPa] | internal pressure [kPa] | area (mm²) | factor [%] |
| Comparative | Li₂ZrOCl₄ | 0 | 101.3 | 0 | 19.7 | 55 |
| Example 3 | | | | | | |
| Example 21 | Li₂ZrOCl₄ | −10 | 91.3 | 10 | 9.0 | 76 |
| Example 22 | Li₂ZrOCl₄ | −20 | 81.3 | 20 | 7.6 | 79 |
| Example 23 | Li₂ZrOCl₄ | −30 | 71.3 | 30 | 5.5 | 85 |
| Example 24 | Li₂ZrOCl₄ | −40 | 61.3 | 40 | 3.6 | 88 |
| Example 25 | Li₂ZrOCl₄ | −50 | 51.3 | 50 | 1.3 | 91 |
| Example 26 | Li₂ZrOCl₄ | −60 | 41.3 | 60 | 0.9 | 95 |
| Example 27 | Li₂ZrOCl₄ | −70 | 31.3 | 70 | 0.67 | 96 |
| Example 28 | Li₂ZrOCl₄ | −80 | 21.3 | 80 | 0.47 | 97 |
| Example 29 | Li₂ZrOCl₄ | −90 | 11.3 | 90 | 0.28 | 98 |
| Example 30 | Li₂ZrOCl₄ | −100 | 1.3 | 100 | 0.26 | 98 |
| Comparative | LiZr(PO₄)_{0.33}Cl₄ | 0 | 101.3 | 0 | 19 | 56 |
| Example 4 | | | | | | |
| Example 31 | LiZr(PO₄)_{0.33}Cl₄ | −10 | 91.3 | 10 | 9.3 | 68 |
| Example 32 | LiZr(PO₄)_{0.33}Cl₄ | −20 | 81.3 | 20 | 7.8 | 75 |
| Example 33 | LiZr(PO₄)_{0.33}Cl₄ | −30 | 71.3 | 30 | 5.8 | 78 |
| Example 34 | LiZr(PO₄)_{0.33}Cl₄ | −40 | 61.3 | 40 | 3.9 | 79 |
| Example 35 | LiZr(PO₄)_{0.33}Cl₄ | −50 | 51.3 | 50 | 2.5 | 85 |
| Example 36 | LiZr(PO₄)_{0.33}Cl₄ | −60 | 41.3 | 60 | 0.92 | 93 |
| Example 37 | LiZr(PO₄)_{0.33}Cl₄ | −70 | 31.3 | 70 | 0.88 | 94 |
| Example 38 | LiZr(PO₄)_{0.33}Cl₄ | −80 | 21.3 | 80 | 0.53 | 95 |
| Example 39 | LiZr(PO₄)_{0.33}Cl₄ | −90 | 11.3 | 90 | 0.29 | 96 |
| Example 40 | LiZr(PO₄)_{0.33}Cl₄ | −100 | 1.3 | 100 | 0.27 | 97 |

TABLE 3

| | | Degree of | | | | |
|---|---|---|---|---|---|---|
| | | vacuum inside | Internal | Difference between | | |
| | | exterior body | pressure | external pressure and | Discoloration | Maintenance |
| Example | Composition | [kPa] | [kPa] | internal pressure [kPa] | area (mm²) | factor [%] |
| Comparative | LiY(PO₄)_{0.33}Cl₃ | 0 | 101.3 | 0 | 20 | 55 |
| Example 5 | | | | | | |
| Example 41 | LiY(PO₄)_{0.33}Cl₃ | −10 | 91.3 | 10 | 9.5 | 66 |
| Example 42 | LiY(PO₄)_{0.33}Cl₃ | −20 | 81.3 | 20 | 7.7 | 74 |
| Example 43 | LiY(PO₄)_{0.33}Cl₃ | −30 | 71.3 | 30 | 5.7 | 77 |
| Example 44 | LiY(PO₄)_{0.33}Cl₃ | −40 | 61.3 | 40 | 4 | 84 |
| Example 45 | LiY(PO₄)_{0.33}Cl₃ | −50 | 51.3 | 50 | 2.7 | 89 |
| Example 46 | LiY(PO₄)_{0.33}Cl₃ | −60 | 41.3 | 60 | 0.95 | 91 |
| Example 47 | LiY(PO₄)_{0.33}Cl₃ | −70 | 31.3 | 70 | 0.86 | 92 |
| Example 48 | LiY(PO₄)_{0.33}Cl₃ | −80 | 21.3 | 80 | 0.51 | 94 |
| Example 49 | LiY(PO₄)_{0.33}Cl₃ | −90 | 11.3 | 90 | 0.29 | 95 |
| Example 50 | LiY(PO₄)_{0.33}Cl₃ | −100 | 1.3 | 100 | 0.26 | 96 |
| Comparative | Li_{1.3}Al_{0.3}Zr_{0.7}(PO₄)_{0.43}Cl_{3.7} | 0 | 101.3 | 0 | 21 | 54 |
| Example 6 | | | | | | |
| Example 51 | Li_{1.3}Al_{0.3}Zr_{0.7}(PO₄)_{0.43}Cl_{3.7} | −10 | 91.3 | 10 | 9.5 | 65 |
| Example 52 | Li_{1.3}Al_{0.3}Zr_{0.7}(PO₄)_{0.43}Cl_{3.7} | −20 | 81.3 | 20 | 8 | 72 |
| Example 53 | Li_{1.3}Al_{0.3}Zr_{0.7}(PO₄)_{0.43}Cl_{3.7} | −30 | 71.3 | 30 | 6 | 76 |
| Example 54 | Li_{1.3}Al_{0.3}Zr_{0.7}(PO₄)_{0.43}Cl_{3.7} | −40 | 61.3 | 40 | 4.1 | 82 |
| Example 55 | Li_{1.3}Al_{0.3}Zr_{0.7}(PO₄)_{0.43}Cl_{3.7} | −50 | 51.3 | 50 | 3.1 | 88 |
| Example 56 | Li_{1.3}Al_{0.3}Zr_{0.7}(PO₄)_{0.43}Cl_{3.7} | −60 | 41.3 | 60 | 0.98 | 91 |
| Example 57 | Li_{1.3}Al_{0.3}Zr_{0.7}(PO₄)_{0.43}Cl_{3.7} | −70 | 31.3 | 70 | 0.9 | 93 |
| Example 58 | Li_{1.3}Al_{0.3}Zr_{0.7}(PO₄)_{0.43}Cl_{3.7} | −80 | 21.3 | 80 | 0.55 | 94 |
| Example 59 | Li_{1.3}Al_{0.3}Zr_{0.7}(PO₄)_{0.43}Cl_{3.7} | −90 | 11.3 | 90 | 0.45 | 95 |
| Example 60 | Li_{1.3}Al_{0.3}Zr_{0.7}(PO₄)_{0.43}Cl_{3.7} | −100 | 1.3 | 100 | 0.31 | 96 |

TABLE 4

| | | Degree of vacuum | Internal | Difference between | | |
|---|---|---|---|---|---|---|
| | | inside exterior | pressure | external pressure and | Discoloration | Maintenance |
| Example | Composition | body [kPa] | [kPa] | internal pressure [kPa] | area (mm²) | factor [%] |
| Comparative | Li_{1.8}Zr(SO₄)_{0.9}Cl₄ | 0 | 101.3 | 0 | 18 | 56 |
| Example 7 | | | | | | |
| Example 61 | Li_{1.8}Zr(SO₄)_{0.9}Cl₄ | −10 | 91.3 | 10 | 9 | 77 |
| Example 62 | Li_{1.8}Zr(SO₄)_{0.9}Cl₄ | −20 | 81.3 | 20 | 7.2 | 79 |
| Example 63 | Li_{1.8}Zr(SO₄)_{0.9}Cl₄ | −30 | 71.3 | 30 | 5.8 | 83 |
| Example 64 | Li_{1.8}Zr(SO₄)_{0.9}Cl₄ | −40 | 61.3 | 40 | 3.5 | 89 |
| Example 65 | Li_{1.8}Zr(SO₄)_{0.9}Cl₄ | −50 | 51.3 | 50 | 1.2 | 92 |
| Example 66 | Li_{1.8}Zr(SO₄)_{0.9}Cl₄ | −60 | 41.3 | 60 | 0.9 | 94 |
| Example 67 | Li_{1.8}Zr(SO₄)_{0.9}Cl₄ | −70 | 31.3 | 70 | 0.7 | 96 |
| Example 68 | Li_{1.8}Zr(SO₄)_{0.9}Cl₄ | −80 | 21.3 | 80 | 0.55 | 97 |
| Example 69 | Li_{1.8}Zr(SO₄)_{0.9}Cl₄ | −90 | 11.3 | 90 | 0.3 | 98 |
| Example 70 | Li_{1.8}Zr(SO₄)_{0.9}Cl₄ | −100 | 1.3 | 100 | 0.25 | 98 |
| Comparative | Li_{2.2}Zr(SO₄)_{1.1}Cl₄ | 0 | 101.3 | 0 | 19 | 54 |
| Example 8 | | | | | | |
| Example 71 | Li_{2.2}Zr(SO₄)_{1.1}Cl₄ | −10 | 91.3 | 10 | 9.1 | 76 |
| Example 72 | Li_{2.2}Zr(SO₄)_{1.1}Cl₄ | −20 | 81.3 | 20 | 7.7 | 78 |
| Example 73 | Li_{2.2}Zr(SO₄)_{1.1}Cl₄ | −30 | 71.3 | 30 | 5.6 | 86 |
| Example 74 | Li_{2.2}Zr(SO₄)_{1.1}Cl₄ | −40 | 61.3 | 40 | 3.5 | 88 |
| Example 75 | Li_{2.2}Zr(SO₄)_{1.1}Cl₄ | −50 | 51.3 | 50 | 1 | 91 |
| Example 76 | Li_{2.2}Zr(SO₄)_{1.1}Cl₄ | −60 | 41.3 | 60 | 0.9 | 93 |
| Example 77 | Li_{2.2}Zr(SO₄)_{1.1}Cl₄ | −70 | 31.3 | 70 | 0.65 | 95 |
| Example 78 | Li_{2.2}Zr(SO₄)_{1.1}Cl₄ | −80 | 21.3 | 80 | 0.53 | 96 |
| Example 79 | Li_{2.2}Zr(SO₄)_{1.1}Cl₄ | −90 | 11.3 | 90 | 0.28 | 97 |
| Example 80 | Li_{2.2}Zr(SO₄)_{1.1}Cl₄ | −100 | 1.3 | 100 | 0.24 | 97 |

TABLE 5

| | | Degree of vacuum | Internal | Difference between | | |
|---|---|---|---|---|---|---|
| | | inside exterior | pressure | external pressure and | Discoloration | Maintenance |
| Example | Composition | body [kPa] | [kPa] | internal pressure [kPa] | area (mm²) | factor [%] |
| Comparative | Li₃Zr(SO₄)_{1.5}Cl₄ | 0 | 101.3 | 0 | 18.5 | 56 |
| Example 9 | | | | | | |
| Example 81 | Li₃Zr(SO₄)_{1.5}Cl₄ | −10 | 91.3 | 10 | 8.7 | 76 |
| Example 82 | Li₃Zr(SO₄)_{1.5}Cl₄ | −20 | 81.3 | 20 | 7.4 | 79 |
| Example 83 | Li₃Zr(SO₄)_{1.5}Cl₄ | −30 | 71.3 | 30 | 5 | 82 |
| Example 84 | Li₃Zr(SO₄)_{1.5}Cl₄ | −40 | 61.3 | 40 | 3.3 | 87 |
| Example 85 | Li₃Zr(SO₄)_{1.5}Cl₄ | −50 | 51.3 | 50 | 1 | 92 |
| Example 86 | Li₃Zr(SO₄)_{1.5}Cl₄ | −60 | 41.3 | 60 | 0.9 | 94 |
| Example 87 | Li₃Zr(SO₄)_{1.5}Cl₄ | −70 | 31.3 | 70 | 0.65 | 96 |
| Example 88 | Li₃Zr(SO₄)_{1.5}Cl₄ | −80 | 21.3 | 80 | 0.5 | 97 |
| Example 89 | Li₃Zr(SO₄)_{1.5}Cl₄ | −90 | 11.3 | 90 | 0.3 | 98 |
| Example 90 | Li₃Zr(SO₄)_{1.5}Cl₄ | −100 | 1.3 | 100 | 0.25 | 98 |

In Tables 1 to 5, the degrees of vacuum inside the exterior body are the degrees of vacuum when atmospheric pressure is converted to 0 kPa. In the all-solid-state batteries according to Examples 1 to 90, the internal pressure inside the accommodation space K was less than 101.3 kPa, discoloration of the positive electrode current collectors and the negative electrode current collectors was prevented, and all of the maintenance factors of Examples 1 to 90 after 50 cycles were better than those of the all-solid-state batteries according to Comparative Examples 1 to 9. When Li₂ZrSO₄Cl₄, Li₂ZrOCl₄, Li_{1.8}Zr(SO₄)_{0.9}Cl₄, Li_{2.2}Zr(SO₄)_{1.1}Cl₄, and Li₃Zr(SO₄)_{1.5}Cl₄ were used as the solid electrolyte and the differences between the external pressure and the internal pressure were 30 kPa or more, the maintenance factors were 80% or more which were favorable. When Li₂ZrCl₆, LiZr(PO₄)_{0.33}Cl₄, LiY(PO₄)_{0.33}Cl₃, and Li_{1.3}Al_{0.3}Zr_{0.7}(PO₄)_{0.43}Cl_{3.7} were used as the solid electrolyte and the differences between the external pressure and the internal pressure were 40 kPa or more, the maintenance factors were 80% or more which were favorable.

### INDUSTRIAL APPLICABILITY

The battery of the embodiment has excellent cycle characteristics and is appropriately applied as a power source for a portable electronic device for which a decrease in size, weight, and thickness and improved reliability are strongly desired.

### EXPLANATION OF REFERENCE SIGNS

11 ⋅ ⋅ ⋅ Positive electrode
11A ⋅ ⋅ ⋅ Positive electrode current collector
11B ⋅ ⋅ ⋅ Positive electrode active material layer
12 ⋅ ⋅ ⋅ External terminal
13 ⋅ ⋅ ⋅ Negative electrode
13A ⋅ ⋅ ⋅ Negative electrode current collector
13B ⋅ ⋅ ⋅ Negative electrode active material layer
14 ⋅ ⋅ ⋅ External terminal
15 ⋅ ⋅ ⋅ Solid electrolyte layer
10 ⋅ ⋅ ⋅ Power storage element
20 ⋅ ⋅ ⋅ Exterior body
22 ⋅ ⋅ ⋅ Metal foil
24 ⋅ ⋅ ⋅ Resin layer
K ⋅ ⋅ ⋅ Accommodation space
100 ⋅ ⋅ ⋅ All-solid-state battery

What is claimed is:

1. A battery comprising:
a power storage element including a positive electrode, a negative electrode, and a solid electrolyte layer located between the positive electrode and the negative electrode; and
an exterior body covering the power storage element,
wherein at least one of the positive electrode, the negative electrode, and the solid electrolyte layer contains a solid electrolyte represented by the following Formula (1):
$${Li}_{3 + a - e} {E}_{1 - b} {G}_{b} {D}_{c} {X}_{d - e} , \qquad ( 1 )$$
in Formula (1),
E is at least one element selected from the group consisting of Al, Sc, Y, Zr, Hf, and lanthanides,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂,
X is at least one element selected from the group consisting of F, Cl, Br, and I, and
when n=(valence of E)−(valence of G), a=nb, 0≤b><0.5, 0≤c≤5, 0<d≤7.1, 0≤e≤2, and 0<d−e are satisfied, and
an internal pressure in an accommodation space enclosed by the exterior body is less than 101.3 kPa.

2. The battery according to claim 1, wherein the internal pressure is less than an external pressure applied to the exterior body and a pressure difference between the external pressure and the internal pressure is 30 kPa or more and 100 kPa or less.

3. A method for producing a battery, the method comprising:
an element preparation step of disposing a solid electrolyte layer between a positive electrode and a negative electrode and subjecting the positive electrode, the solid electrolyte layer, and the negative electrode to pressure-molding to prepare a power storage element;
a step of preparing an exterior body having an opening portion;
a step of accommodating the power storage element inside the exterior body; and
a step of making an inside of the exterior body have a vacuum state, setting an internal pressure in an accommodation space to be less than 101.3 kPa, and sealing the opening portion of the exterior body,
wherein at least one of the positive electrode, the negative electrode, and the solid electrolyte layer contains a solid electrolyte represented by the following Formula (1):
$${Li}_{3 + a - e} {E}_{1 - b} {G}_{b} {D}_{c} {X}_{d - e} , \qquad ( 1 )$$
in Formula (1),
E is at least one element selected from the group consisting of Al, Sc, Y, Zr, Hf, and lanthanides,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂,
X is at least one element selected from the group consisting of F, Cl, Br, and I, and
when n=(valence of E)−(valence of G), a=nb, 0≤b<0.5, 0≤c≤5, 0<d≤7.1, 0≤e≤2, and 0<d−e are satisfied.
